(19) United States
(12) Patent Application Publication
(10) Pub. No.: US 2010/0254223 A1
(43) Pub. Date: Oct. 7, 2010

(54) ANNIVERSARY COUNTDOWN TIMEPIECE

(76) Inventor: Crispin Jones, London (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/755,706

(22) Filed: Apr. 7, 2010

Related U.S. Application Data
(60) Provisional application No. 61/167,423, filed on Apr. 7, 2009.

(51) Int. Cl. G04G 9/00; G04B 47/00

(52) U.S. Cl. 368/10

(57) ABSTRACT

Embodiments of the present invention relate to an electronic or mechanical timepiece, such as a clock or calendar, comprising: a user interface for allowing a user to enter a date; a timekeeping module unit connected to the user interface, wherein the timekeeping module calculates the time remaining to an anniversary of the date, a memory connected to the timekeeping module comprising a look-up table of gift information; and a display for displaying the calculated time remaining until the anniversary of the date together with gift information from the look-up table associated with the anniversary. By providing a countdown to an anniversary date together with associated gift information, for example, from a particular wedding anniversary gift list, a timepiece in accordance with the present invention provides additional, useful information over and above known countdown clocks.

This application claims priority to U.S. patent application Ser. No. 61/167,423, filed Apr. 7, 2009.

### FIELD OF THE INVENTION

Certain embodiments of the present invention relate to timepieces, such as clocks and calendars, that provide a countdown to an anniversary date and in certain particular embodiments a wedding anniversary date, together with an indication of a gift or material associated with the anniversary.

### BACKGROUND OF THE INVENTION

Countdown calendars and clocks provide a display of the time or number of days remaining to a particular event. For example, GB 2304939A describes a clock with a display for counting down to twelve midnight on Dec. 31, 1999.

It is possible to allow a user to program personally significant dates into a countdown clock, in order to provide a countdown to those dates. GB 2310736 discloses a calendar which has two displays, one showing the current date and one showing the number of days to a particular event, such as a birthday. An indication of the event can be included such as “birthday” or “holiday”.

### SUMMARY OF THE INVENTION

Certain embodiments of the present invention provide an electronic or mechanical timepiece, such as a clock or calendar, comprising a user interface for allowing a user to enter a date; a timekeeping module connected to the user interface, wherein the timekeeping module calculates the time remaining to an anniversary of the date, a memory connected to the timekeeping module comprising a look-up table of gift information; and a display for displaying the calculated time remaining until the anniversary of the date together with gift information from the look-up table associated with the anniversary.

These embodiments of present invention therefore provide a countdown clock or calendar for an anniversary that not only indicates the time remaining to a specified anniversary date but also provides information about an appropriate gift. On wedding anniversaries it is traditional to give a gift to your partner (or to the couple) that symbolizes the particular anniversary. Typically a different material, such as silver or gold, is used to symbolize each wedding anniversary.

There are currently two main gift lists that are used in western Europe and the United States. These are the traditional wedding anniversary gift list and the modern wedding anniversary gift list. The material or item chosen for each year in each of these gift lists is not easy to remember, nor is there a material or gift associated with every year. For example, in the traditional lists, after the fifteenth year, a gift is associated only with every fifth anniversary.

By providing a countdown to an anniversary date together with associated gift information, for example from a particular wedding anniversary gift list, a timepiece in accordance with certain embodiments of the present invention provides additional, useful information over and above known countdown clocks.

In certain embodiments of the invention, a look-up table is included and comprises a single anniversary gift list, either the traditional or the contemporary list, which is stored in the memory during manufacture. The manufacturer or retailer could also store their own gift list. For example, the retailer might specify a particular list of their products and could ask the manufacturer to store that list in the look-up table. Alternatively, in another aspect, the clock or calendar comprises a user interface that allows a user to enter their own list, to be stored as a look-up table, subsequent to manufacture.

The clock or calendar could be used to provide a countdown to a single wedding anniversary or alternatively may be used to provide a countdown to multiple wedding anniversaries. The memory could hold the date of a number of different wedding anniversaries and the display could cycle through them, indicating how long to the various anniversaries together with an associated gift.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

Examples of embodiments of the present invention will now be described in detail, with reference to the accompanying drawings, in which:

FIG. 1 is a schematic diagram showing the basic elements of a clock in accordance with the embodiments of the present invention; and

FIG. 2 illustrates a display of a clock in accordance with the embodiments of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention.

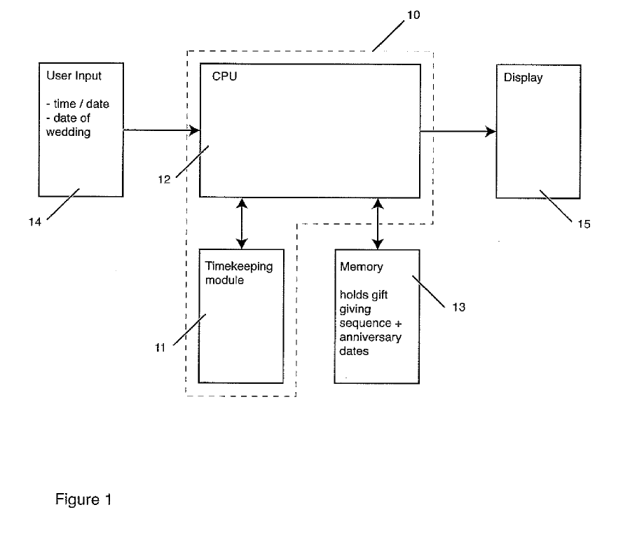

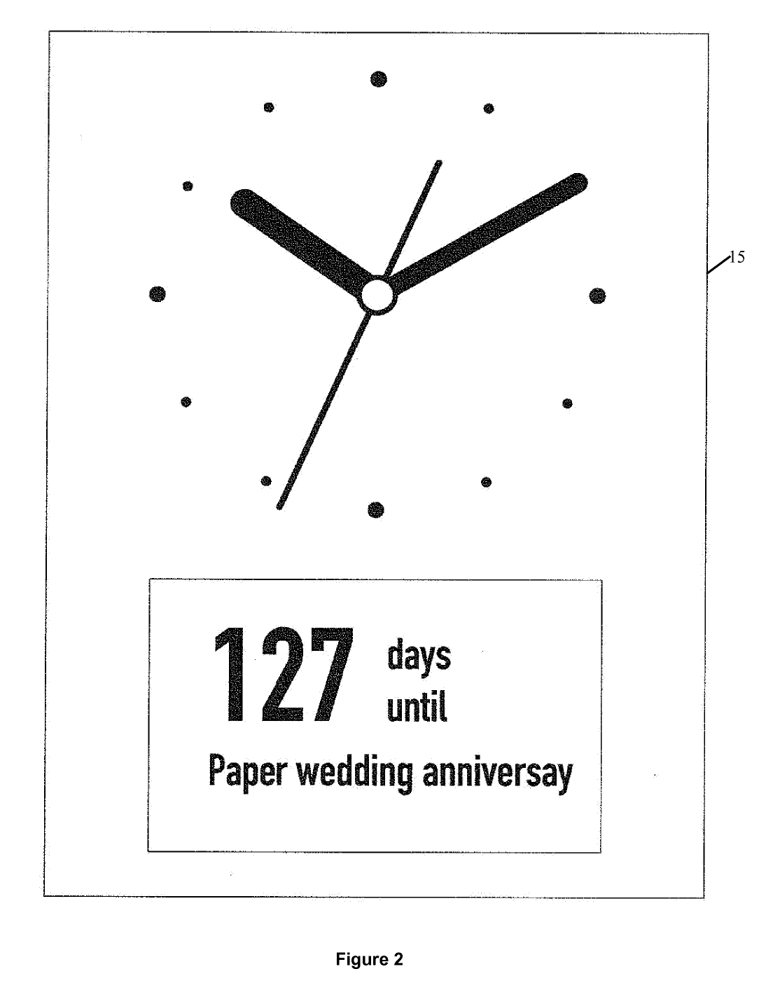

An example of one of the embodiments of the present invention is shown in FIG. 1. FIG. 1 is a block diagram showing the basic elements of an embodiment of the invention. The embodiment shown in FIG. 1 is of a clock which displays both the current time and a countdown to an anniversary date. A display of this type is illustrated in FIG. 2.

The clock of FIG. 1 comprises an electronic timekeeping module 10 comprising a clock module 11 and a microprocessor 12. The clock module provides an indication of the current time and passes this to the microprocessor. Additionally, the microprocessor can set the clock module. For example, when the clock is first turned on and the user sets the current time and date, this information is passed via the microprocessor to the clock module.

The microprocessor 12 is connected to a memory 13 which includes a look-up table of gifts and associated anniversary years. The look-up table may contain the traditional wedding gift list as shown below.

| Year | Gift |
|---|---|
| 1^{st} | Paper |
| 2^{nd} | Cotton |
| 3^{rd} | Leather |
| 4^{th} | Linen, Silk |
| 5^{th} | Wood |
| 6^{th} | Iron |
| 7^{th} | Wool, Copper |
| 8^{th} | Bronze |
| 9^{th} | Pottery, China |
| 10^{th} | Tin, Aluminum |
| 11^{th} | Steel |
| 12^{th} | Silk |
| 13^{th} | Lace |
| 14^{th} | Ivory |
| 15^{th} | Crystal |
| 20^{th} | China |
| 25^{th} | Silver |
| 30^{th} | Pearl |
| 35^{th} | Coral, Jade |
| 40^{th} | Ruby |
| 45^{th} | Sapphire |
| 50^{th} | Gold |
| 55^{th} | Emerald |
| 60^{th} | Diamond |
| 80^{th} | Oak |

Alternatively, a modern list may be used, or a user defined list. The memory may include a number of different look-up tables each holding a different gift list or a single look-up table containing a plurality of different gift lists.

The microprocessor is also connected to a user input 14 and a display 15.

The user input means 14 is provided to allow a user to input a wedding date or dates. The user input means is, for example, in the form of a single button or a pair of buttons. However, any suitable user input means may be provided.

The entered wedding date is stored in memory 13. The microprocessor 12 calculates the time remaining until an anniversary of the wedding date, as well as the number of years that that anniversary will mark since the wedding date. The microprocessor obtains the relevant gift information for that number of years from the look-up table. The microprocessor then sends this information to the display 15.

The display shows the current time (in digital or analogue format) as well as the number of days remaining until the anniversary and the associated gift information. An example of this is shown in FIG. 2.

The memory 13 may store a plurality of look-up tables, each comprising a different gift list. The display can then be made to cycle through different lists by the microprocessor in response to an input from the user interface or a preference setting in the software running on the microprocessor.

The memory may also store a plurality of anniversary dates, so that a user can scroll between friends or family's anniversary dates. In this case, a name associated with each anniversary may be input and stored in memory 13 and may be displayed on display 15 in conjunction with the countdown and gift information.

In one embodiment, a user is able to put their own gift list in place of, or in addition to, the pre-programmed gift lists. The personal gift list can be entered using user input means 14 and stored in a look-up table within the memory 13.

The embodiment described with reference to FIGS. 1 and 2 takes the form of a clock. However, the invention is equally applicable to an electronic calendar or a combination of a clock and calendar.

In addition to the information described above, any further information that is desired may be displayed on display 15.

1. An electronic or mechanical timepiece comprising:
a user interface for allowing a user to enter a date;
a timekeeping module connected to the user interface, wherein the timekeeping module calculates the time remaining to an anniversary of the date;
a memory connected to the timekeeping module comprising a look-up table of gift information; and
a display for displaying the calculated time remaining until the anniversary of the date together with gift information from the look-up table associated with the anniversary.

2. The timepiece according to claim 1, wherein the date is a wedding date.

3. The timepiece according to claim 1, wherein the display includes an indication of the current time.

4. The timepiece according to claim 1, wherein the display includes an indication of the current date.

5. The timepiece according to claim 1, wherein the memory stores the date entered by a user.

6. The timepiece according to claim 5, wherein the memory stores a plurality of dates entered by the user, wherein the timekeeping module calculates the time remaining to an anniversary of each of the dates, and the display can display the calculated time remaining until an anniversary of each of the dates together with gift information from the look-up table associated with each anniversary.

7. The timepiece according to claim 1, wherein the memory stores a plurality of alternative tables of gift information.
